(19) United States
(12) Patent Application Publication
(10) Pub. No.: US 2014/0272919 A1
(43) Pub. Date: Sep. 18, 2014

(54) CORE BOARD

(71) Applicant: Steven A Schulman, Norwalk, CT (US)

(72) Inventor: Steven A Schulman, Norwalk, CT (US)

(21) Appl. No.: 13/844,997

(22) Filed: Mar. 17, 2013

(51) Int. Cl. G09F 15/00

(52) U.S. Cl. CPC G09F 15/0006
USPC 434/428

(57) ABSTRACT

The present invention is an improved core board, being lightweight for convenient use and having dual performance with two sides capable of accepting application of inks, paint, markings, lettering, design and glues, as well as being suitable for cutting and mounting.

### CROSS-REFERENCE TO RELATED APPLICATIONS

This application claims priority to commonly assigned U.S. provisional application Ser. No. 61/729,025 filed Nov. 21, 2012, entitled “CHALKBOARD FOAM BOARD” and U.S. provisional application Ser. No. 61/729,044 filed Nov. 21, 2012, and entitled “DRY ERASE FOAM BOARD”, the complete disclosure of which is hereby incorporated in their entirety by reference herein.

### TECHNICAL FIELD

The present invention is in the technical field of core layered materials and more particularly, in the technical field of a lightweight core board for graphic art and design, having two sides capable of accepting application of inks, paint, markings, lettering, design and glues, as well as being suitable for cutting and mounting. For the purpose of the preferred embodiment of the present invention, the term “core board” may include of any resultant board with three layers, having an inner layer of polystyrene or other polymer material with one or more layer of outer surface, such as bleached, semi-gloss white clay-coated paper, coated or kraft paper, or colored paper.

### BACKGROUND

Core board is a medium suitable for a wide variety of graphic and display uses, including but not limited to art board signage and display board. Core board can be used for projects, presentation of information, temporary signage, backing artwork, mounting photographic and art prints, framing, 3D design and sculpture or the like. In general, graphic art and design mediums accept inks, paint, and glues on only one side. Where the opposing side is used with the inks, paint, or glues, there is often significant smearing or other failure in the ink adhering to the underlying core board. In the present innovation, two sides of the core board are capable of accepting application of inks, paint, markings, lettering, design and glues, as well as being suitable for cutting and mounting and therefore such core board is improved as a dual performance core board which is more versatile for the user.

### BRIEF DESCRIPTION

Accordingly, it is an object of the present invention to overcome some of the drawbacks relating to the designs of prior art devices as discussed above. The principal object of the invention herein is to provide a durable lightweight, dual performance core board capable of accepting application of inks, paint, markings, lettering, design, and glues, as well as being suitable for cutting and mounting. These and other objects, features, and advantages of this invention will become apparent to one skilled in the art upon review of the following specification in conjunction with the drawings.

### BRIEF DESCRIPTION OF THE DRAWINGS

Having thus described the present invention in general terms, reference will now be made to the accompanying drawings, which are not necessarily drawn to scale, and wherein:

FIG. 1 is a sectional view of the core board of the present invention; and

FIG. 2 is a sectional view of an alternate embodiment of the present invention.

It should be understood that the drawing is for purposes of illustrating the concepts of the present invention and are not necessarily the only possible configurations for illustrating the present invention.

### DETAILED DESCRIPTION

The preferred embodiments of the present invention now will be described more fully hereinafter with reference to the accompanying drawings, in which some examples of the embodiments of the present invention are shown. Indeed, the present invention may be embodied in many different forms and should not be construed as limited to the embodiments set forth herein. Like numbers refer to like elements throughout.

The following is a detailed description of a preferred embodiment of the invention. The preferred embodiment is in such detail as to clearly communicate the invention. However, the amount of detail offered is not intended to limit the anticipated variations of embodiments; but, on the contrary, the intention is to cover all modifications, equivalents, and alternatives falling within the spirit and scope of the preferred embodiment of the present invention. While the detailed description below enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and example, but by all embodiments and methods within the scope and spirit of the invention as claimed. In carrying out the preferred embodiment of the present invention as shown in FIG. 1, a core board 10 is provided with a core layer 12 and at least one first base layer 14 and at least one second base layer 16 respectively adhered to opposite surfaces of the core layer 12, with the core board having a basis weight of less than 500 g/m².

In the preferred embodiment, the core layer is substantially rigid, flat and highly warp resistant. The core layer is polystyrene foam and lightweight due to core layer density of less than 0.10 g/cm³ in construction. In an alternate embodiment, the core layer is made of a polymer material. The core layer 12, the first base layer 14 and the second base layer 16 are selected for secure adherence to each other by methods that are advantageous with respect to both the first base layer 14 and second base layer 16 and the core layer 12. The base layers 14, 16 have a coating semi-gloss white clay-coated paper, coated or kraft paper, or colored or patterned paper. In one embodiment the base layers are bleached, to suit user preference. In another embodiment, the base layer is transparent.

It is conceived that the first base layer 14 and second base layer 16 could have different coatings and present in different colors. It is additionally conceived that at least one of the first base layer 14 and second base layer 16 is patterned, including but not limited to gridlines, or colored, or is adapted to receive chalk, dry erase marker or the like. In the preferred embodiment, adherence between the core layer 12 and the first base layer 14 and second base layer 16 is by adhesive. It is conceived that adherence between the core layer 12 and the first base layer 14 and second base layer 16 is by a pressure sensitive vinyl decal film or a static cling. It is additionally conceived that the adhesive is chemical based, or plant based, such as a wheat starch paste or methylcellulose. As shown in FIG. 2, it is additionally conceived that there is more than first base layer 14 and second base layer 16 which is adhered to a side of the core layer 12, such as a first prime base layer 18 secured to the outside of said first base layer 14 and a second prime base layer 20 secured to the outside of said second base layer 16.

In the preferred embodiment of the preferred embodiment of the present invention, the first base layer 14 and second base layer 16 are substantially smooth and configured as capable of accepting application of inks, paint, markings, lettering, design and glues, as well as being suitable for cutting and mounting. In the preferred embodiment, the core layer 12 has a paper weight in the range of approximately 9 points to 25 points and less than 300 millimeters and the first base layer 14 and second base layer 16 function in part as stiffening elements, which are joined to opposite sides of the core layer 12.

The advantages of the preferred embodiment of the present invention include, without limitation, a lightweight core board 10 which is substantially rigid, flat and highly warp resistant, where such core board 10 is improved to be dual performance as it can have two sides capable of accepting application of inks, paint, markings, lettering, design and glues, as well as being suitable for cutting and mounting to be more versatile for the user.

Although the preferred embodiment of the present invention and some of its advantages have been described in detail for the embodiment, it should be understood that various changes, substitutions, and alterations can be made herein without departing from the spirit and scope of the invention. Although an embodiment of the invention may achieve multiple objectives, not every embodiment falling within the scope of the invention will achieve every objective, Moreover, the scope of the present application is not intended to be limited to the particular embodiments of the process, methods and steps hereof. As one of the ordinary skill in the art will readily appreciate from the disclosure of the preferred embodiment of the present invention, processes, methods, or steps, presently existing or later to be developed that perform substantially the same function or achieve substantially the same result as the corresponding embodiments described herein may be utilized according to the preferred embodiment of the present invention. Accordingly, any claims of the preferred embodiment of the present invention are intended to include with their scope such processes, methods, or steps. The invention should therefore not be limited by the above described embodiment, method, and examples, but by all embodiments and methods within the scope and spirit of the invention as claimed.

What is claimed is:

1. A core board with two sides capable of accepting application of inks, paint, markings, lettering, design and glues, as well as being suitable for cutting and mounting, having at least three layers, comprising:
an inner layer of polystyrene or other polymer material, having a density less than approximately 0.10 g/cm³ and thickness less than approximately 300 millimeters;
said inner layer positioned between a first outer facing layer means and a second outer facing board layer means, on opposite side of the inner layer from the first outer facing layer means;
said first outer layer means and said second outer facing layer means each having a generally flat surface further comprising at least one outer layer adapted for accepting application of inks, paint, markings, lettering, design and glues, as well as being suitable for cutting and mounting; and
said core board having a basis weight of less than 500 g/m².

2. The core board of claim 1, having a paper weight in the range of approximately 9 points to 25 points.

3. The core board of claim 1, wherein said outer layer is bleached, semi-gloss white clay-coated or kraft paper, or colored paper.

4. The core board of claim 1, wherein at least one outer layer is transparent.

5. The core board of claim 1, wherein at least one outer layer is adapted to receive chalk.

6. The core board of claim 1, wherein at least one outer layer is adapted to receive dry erase marker.

7. A core board having three layers with a basis weight of less than 500 g/m² and a paper weight in the range of approximately 9 points to 25 points, said core board comprising an inner layer between a first outer facing layer and a second outer facing board layer, on opposite side of the core layer from the first outer facing layer, wherein said first outer facing layer and said second outer facing layer are bleached, semi-gloss white clay-coated paper, coated or kraft paper, or colored paper adapted for accepting application of inks, paint, markings, lettering, design and glues, as well as being suitable for cutting and mounting.

8. The core board of claim 7, wherein at least one outer layer is adapted to receive chalk.

9. The core board of claim 7, wherein at least one outer layer is adapted to receive dry erase marker.

10. The system of claim 1, comprising.

11. A core board with two sides capable of accepting application of inks, paint, markings, lettering, design and glues, as well as being suitable for cutting and mounting, having three layers, comprising:
an inner layer of polystyrene or other polymer material, having a density less than approximately 0.10 g/cm³ and thickness less than approximately 300 millimeters;
said inner layer positioned between a first outer facing layer and a second outer facing board layer, on opposite side of the inner layer from the first outer facing layer;
said first outer layer and said second outer facing layer each having a generally flat surface of bleached, semi-gloss white clay-coated paper, coated or kraft paper, or colored paper adapted for accepting application of inks, paint, markings, lettering, design and glues, as well as being suitable for cutting and mounting; and
said core board having a basis weight of less than approximately 500 g/m² and having a paper weight in the range of approximately 9 points to 25 points.

12. The core board of claim 10, further comprising a first prime outer layer secured to the outside of said first outer layer and a second prime outer layer secured to the outside of said second outer layer.

13. The core board of claim 10, wherein at least one outer layer is adapted to receive chalk.

14. The core board of claim 10, wherein at least one outer layer is adapted to receive dry erase marker.
